(19) United States
(12) Patent Application Publication
(10) Pub. No.: US 2022/0333406 A1
(43) Pub. Date: Oct. 20, 2022

(54) DOOR BARRICADE

(71) Applicant: Dome Group Holdings, LLC, High Point, NC (US)

(72) Inventor: Paul J. Norcross, High Point, NC (US)

(73) Assignee: Dome Group Holdings, LLC, High Point, NC (US)

(21) Appl. No.: 17/230,018

(22) Filed: Apr. 14, 2021

(51) Int. Cl. E05B 17/20; E05C 19/00; E05C 1/04

(52) U.S. Cl. CPC E05B 17/2015; E05C 19/003; E05C 1/04; E05B 2063/0039

(57) ABSTRACT

A door safety barricade capable of preventing an intruder from entering through a door in a classroom, a school, an office building, and the like, when the device is in an engaged, locked position and wherein the selected authorities will be automatically notified as the locking device passes by the sensor while being engaged.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a door safety barricade. In particular, the present invention relates to a device for barricading a door from the interior of a room during an emergency situation and notifying appropriate authorities.

### Description of Related Art

The more frequent occurrence of intruders in schools, businesses, and government facilities has highlighted the need for stricter safety measures to be put into place for people working at or using such facilities, such as students in a school. Schools and other facilities have a constant need to be able to have the ability to prevent or attempt to prevent an intruder from entering classrooms, offices, federal buildings, and the like. In an intruder situation, many places go into a lockdown situation where people remain in place and cannot leave the premises until notified. First responders can take an average of 18 minutes before they are able to reach the situation if security is not readily present and, as such, keeping the occupants of a room or building safe from entry by an intruder is a critical effort while waiting for first responders. An effective door barricade is needed to allow time for the first responders to arrive and protect the room/building occupants.

In schools, and most buildings, there are many kinds of doors. Some swing outward, while others swing inward. In addition, some doors are double doors that open in the center of the two doors, either in or out. Furthermore, many schools and the like do not allow door locks on the interior side of the door. Where there are door locks, it is required that the occupants of the room exit into the hallway in order to be able to utilize the door lock, which could easily be entering them into the line of danger.

Many rooms in these situations have a window in the door, or next to the door, making it relatively easy to break the window and reach inside to access the interior door knob to unlock and open the door.

The current devices attempting to deal with these types of situations have used various approaches, including devices that attach to the doorjamb. However, the door can still easily be kicked in by breaking the door jamb. There are a number of devices that attach between the inside face of the door and the floor, but they all have a removable pin, key, or the like, which can be lost or stolen, rendering the device useless in an emergency. Many devices are complicated and can have difficulties while in use.

### BRIEF SUMMARY OF THE INVENTION

The present invention relates to an interior door barricade which notifies authorities when the door barricade has been engaged. Because of the simple mechanism that engages the door bolt and the communication device, it becomes more cost effective and much simpler to use than that of prior devices.

Accordingly, in one embodiment, there is a door barricade for a door designed for mounting between an interior face of the door and an adjacent floor comprising:
a) a door interior face mounting plate;
b) a spring-loaded vertical bolt capable of moving up and down;
c) a front plate for mounting the vertical bolt in an open column, the vertical bolt having a handle which allows the vertical bolt to move between a disengaged up position and an engaged lower position, wherein the bottom of the vertical bolt fits into the floor receiver hole when the vertical bolt is in the lower position;
d) a floor plate with a vertical bolt receiver hole on the floor adjacent to the interior face of the door; and
e) a sensor positioned to detect when the vertical bolt is in the engaged or disengaged position and notifies selected authorities.

### BRIEF DESCRIPTION OF THE DRAWINGS

FIG. 1 is a partially assembled exploded perspective view of the device of the present invention.

FIG. 2 is an exploded perspective view of the device of the present invention.

FIG. 3 is a frontal perspective view of the present invention showing the vertical bolt has passed through the receiver hole of the floor plate.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “door barricade” refers to a mechanism which can secure and fortify an entryway door to withstand an attempt to gain entry by force. In the case of the present invention, it is easily engaged and works regardless of other conventional locking mechanisms on the door. The present invention door barricade is a device that mounts on both the interior face of a room door (such as a classroom) and on the adjacent floor to the interior face of the door, preventing the opening of the door by the connection of the door to the floor.

As used herein, the term “interior face of the door” refers to the side of a room door, such as a classroom, which faces the interior of the room. The exterior face is the opposite side of the door where a person would approach to gain entry, such as from the outside or from a hallway into a classroom.

As used herein, the term “adjacent floor” refers to the floor in the room closest to the interior face of the door. This can be clearly seen in the drawings and is clear from the description herein.

As used herein, the term “door interior face mounting plate” refers to a plate mounted against the interior face of the door to be barricaded. It acts to help attach the front plate to the door, and acts to prevent access to the device or access to the interior of a room or building by going through the door from the outside. The mounting plate can be made from any sufficiently strong metal or reinforced material to resist damage or breaking. It therefore can be steel (e.g., rolled steel), titanium, thick aluminum, or the like.

As used herein, the term “spring-loaded vertical bolt” refers to a metal pin or bar that is positioned vertically inside a column and mounted on the front plate. The spring-loaded vertical bolt has an attached handle for engaging the spring-loaded vertical bolt to the locked lower position. The spring is mounted on the vertical bolt in a manner that biases the bolt to the up position. The bolt can be steel, aluminum, or other rigid material or metal. The bolt is held in the lower position by a channel, wherein the handle can rotate to the side and lock in a manner that the spring cannot return to the up position without rotating the handle back to its starting point.

As used herein, the term “front plate” refers to a second plate which mounts directly onto the mounting plate and has a column designed in such a manner that a vertical bolt is held between both the mounting plate and the front plate, allowing the bolt to move up and down, as well as circumferentially at a bottom of a channel to keep the vertical bolt in the engaged lower position. It is also made of steel, thick aluminum, or other rigid sturdy metal.

As used herein, the term “bias to an up position” refers to the spring on the vertical bolt and being positioned such that when not in a locked engaged position, the spring will return the bolt to the up position

As used herein, the term “handle” refers to a handle attached essentially perpendicular to the vertical bolt, as shown in the figures. It is designed to move the vertical bolt from an unlocked up position to a locked lower position. The spring bias returns the handle and vertical bolt to the up position when the handle is not locked in the engaged lower position.

As used herein, the term “floor plate with a vertical bolt receiver hole” refers to a metal plate mounted into the adjacent floor by screwing, bolting, or the like, so that it is fixed in position. The floor plate has a hole in it, such as a round, rectangular, or slot-like hole, that functions as a receiving hole to receive the bottom of the vertical bolt and holds it in place in the floor in a manner that prevents the door from opening.

As used herein, the term “sensor” refers to a device that detects the door barricade is in the engaged or disengaged configuration and can notify selected authorities such as police, fire, building administration, and the like of the door barricade status. It is engaged by the sensor having a detector that senses the movement of the vertical bolt to the engaged and locked lower position. In one embodiment, there is a magnet on the vertical bolt which passes by the sensor and triggers the detection, subsequently notifying the selected authorities.

### DRAWINGS

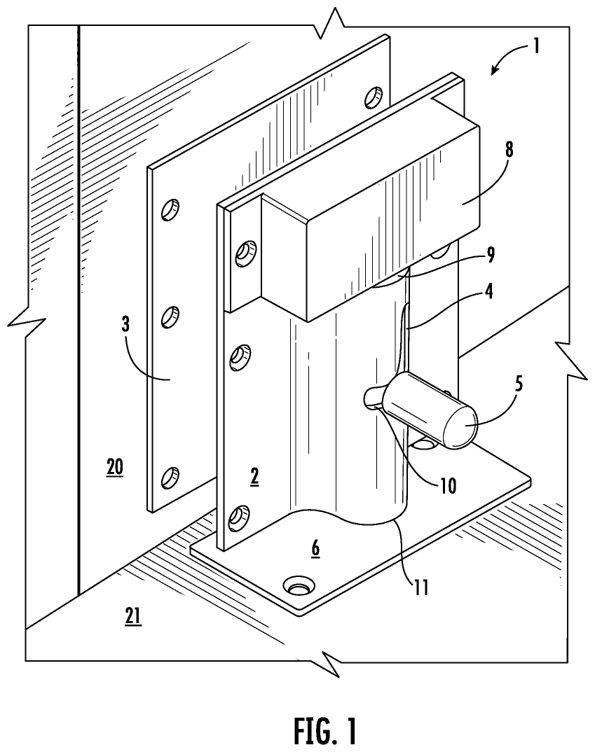

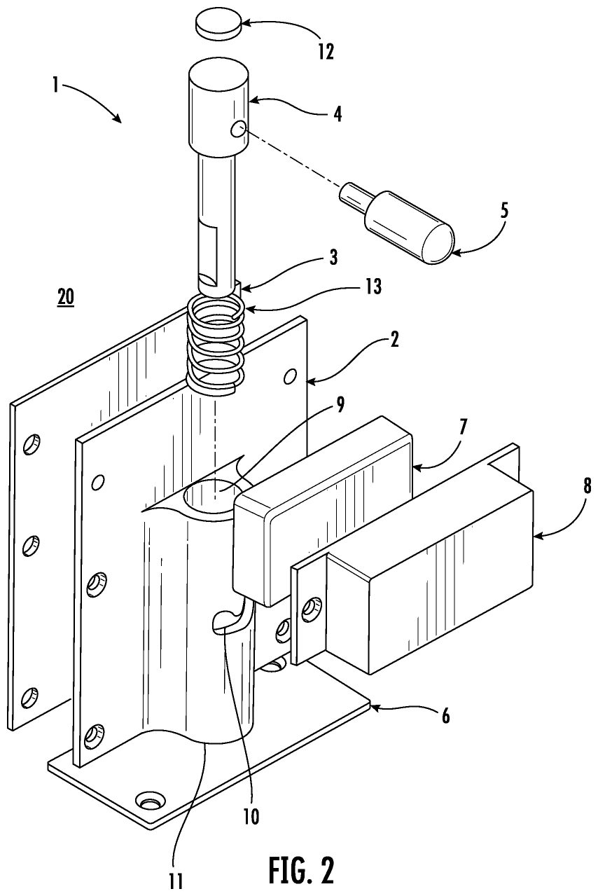

Now referring to the drawings, FIG. 1 is a partially assembled exploded view of the door barricade 1 of the present invention. In this view, a back plate 3 is mounted on an interior face of a room door 20. A front plate 2 is mounted to the back plate 3. The front of the front plate 2 has a hollow column 9, wherein the vertical bolt 4 and attached biasing spring 13 (shown in FIG. 2) are positioned with attached handle 5. Handle 5 moves into channel 10 from an unlocked up position to a locked lower position, wherein the handle 5 has been rotated to the side into channel 10 to prevent the biasing spring 13 from returning the vertical bolt 4 to the unlocked up position. The locked lower position of vertical bolt 4 is positioned in the receiver hole 11 (hidden in the engaged position) in floor plate 6, which is attached to floor 21. Using handle 5, channel 10 allows the vertical bolt 4 to move from an unlocked (disengaged) up position to a locked engaged lower position. Mounted on the front plate 2 is sensor 7 (shown in FIG. 2) with a sensor cover 8. The sensor 7 is designed to notify the selected authorities when the vertical bolt 4 is in the locked engaged lower position. In this embodiment, magnet 12 (shown in FIG. 2) engages the sensor 7 when the magnet 12 passes by the sensor 7 on its way to being in the locked engaged lower position with the vertical bolt 4 in the receiver hole 11.

FIG. 2 shows an exploded perspective view of the present invention with positioning on the door 20. Shown in this figure is the vertical bolt 4, which can be positioned into the receiver hole 11 during use. The handle 5 rotates to the side in the channel 10 to lock it in place, positioning the vertical bolt 4 in the receiver hole 11. In this view, the bias spring 13 is outside the column 9 below the vertical bolt 4, which would be in a compressed state when the vertical bolt 4 is engaged in a lower position. Showing is sensor 7 with sensor cover 8. In this embodiment, a magnet 12 is positioned above vertical bolt 4. However, functionally, magnet 12 is positioned on vertical bolt 4 and is designed to trigger the sensor 7 to indicate an engaged or disengaged state as the magnet 12 passes by sensor 7.

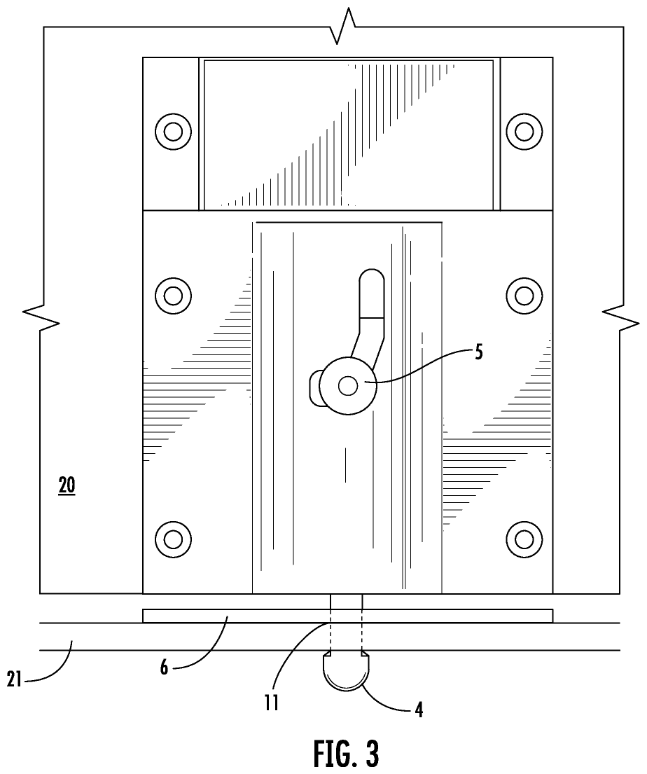

FIG. 3 is a frontal view of the door barricade of the present invention showing a view of handle 5 and vertical bolt 4 in the locked engaged lower position, through the receiver hole 11, floor plate 6, and into the floor 21.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A door barricade for a door designed for mounting between an interior face of the door and an adjacent floor comprising:
a) a door interior face mounting plate;
b) a spring-loaded vertical bolt capable of moving up and down;
c) a front plate for mounting the vertical bolt in an open column, the vertical bolt having a handle which allows the vertical bolt to move between a disengaged up position and an engaged lower position, wherein the bottom of the vertical bolt fits into the floor receiver hole when the vertical bolt is in the lower position;
d) a floor plate with a vertical bolt receiver hole on the floor adjacent to the interior face of the door; and
e) a sensor positioned to detect when the vertical bolt is in the engaged or disengaged position and notifies selected authorities.

2. The door barricade for a door designed for mounting between an interior face of the door and an adjacent floor according to claim 1, wherein the sensor is engaged by a magnet positioned on the vertical bolt.

3. The door barricade for a door designed for mounting between an interior face of the door and an adjacent floor according to claim 1, wherein the handle on the vertical bolt moves through a channel, where the bottom of the channel is shaped to hold the vertical bolt in the lower position.
